(19) United States
(12) Patent Application Publication
(10) Pub. No.: US 2026/0141223 A1
(43) Pub. Date: May 21, 2026

(54) SYSTEMS AND METHODS FOR DYNAMIC GENERATION, MANAGEMENT, AND OPTIMIZATION OF INTERACTIVE WEB CONTENT

(71) Applicant: Zmags Corp., Boston, MA (US)

(72) Inventors: William Ryan Breen, Lexington, MA (US); Imad Mouline, Briantree, MA (US)

(21) Appl. No.: 18/949,973

(22) Filed: Nov. 15, 2024

Related U.S. Application Data
(60) Provisional application No. 63/543,491, filed on Oct. 10, 2023.

(51) Int. Cl. G06N 3/0475; G06F 16/958

(52) U.S. Cl. CPC G06N 3/0475; G06F 16/958

(57) ABSTRACT

Embodiments provide systems and methods for dynamically generating, managing, and optimizing interactive Web content. A generative artificial intelligence model is used to automatically generated a Web page experience in response to a prompt. The Web page experience may include at least one Web page having visual content and functional content created by the generative AI model. The disclosed techniques may also include monitoring, by one or more processors, performance metrics of the at least one Web page, where the metrics may be generated by the functional content. The disclosed techniques may also include determining, by the one or more processors, whether to remove the at least one Web page from circulation based on performance metrics. In an aspect, multiple variants of the Web page experience may be generated, and the determination to remove the at least one Web page may remove one variant from circulation, but not other variants.

### CROSS-REFERENCE TO RELATED APPLICATIONS

The present application claims the benefit of priority from U.S. Provisional Application No. 63/543,491 filed Oct. 10, 2023 and entitled “SYSTEMS AND METHODS FOR DYNAMIC GENERATION AND MANAGEMENT OF INTERACTIVE WEB CONTENT,” the disclosure of which is incorporated by reference herein in its entirety.

### TECHNICAL FIELD

The present disclosure generally relates to systems for creating web content and more specifically, to systems and methods for dynamically generating, managing, and optimizing interactive web content.

### BACKGROUND

Access to the Internet has become widespread and with the proliferation of Internet capable mobile devices, has become accessible from almost anywhere. As a result, use of the Internet has become deeply integrated into many aspects of daily life. For example, the Internet is one of the primary mediums for communication, such as e-mail communications, voice communications (e.g., voice calls over Wi-Fi, voice over internet protocol (VoIP), etc.), and other forms of communication. The Internet also plays a vital role in how people buy goods and services (e.g., e-commerce), distribute and consume information (e.g., blogs, online news sites, and the like), and access entertainment (e.g., streaming music, movies, and the like). As a result of the increased accessibility, ease of use, and other capabilities, the Internet has developed into a robust and competitive landscape in which enterprises compete for the attention of Internet users. For example, entities often utilize designers (e.g., graphics designers or other artists) to design appealing content for display to users on websites. The designers utilize specialized software programs to create visually appealing displays of text, images, and other forms information. While visually appealing, the content created by the designer is merely static visual data (e.g., graphics, images, etc.) and is not readily deployed to the Internet. For example, a single design file may include visual content for one or more pages of a website that may be displayed in a Web browser.

To create a more engaging experience for the users, entities provide the design file to a Web developer who is tasked with transforming the designer's work into engaging web content. In particular, the web developer recreates various pieces of the visual content included in the design file in a format suitable for presentation as a web page and builds hypertext markup language (HTML) and other forms of code (e.g., JavaScript) to support the functionality of the Web page or website being built. The need to use both a designer and a developer can slow down or delay deployment of web content and may even result in a loss of some of the creative expression of the designer's work (e.g., based on the recreation of the visual content by the web developer). Additionally, existing techniques for generating web content may also result in decreased performance when loading the web content due to the manner in which the web developers reproduce the content of the design file.

Other challenges also exist. For example, for many entities use Web pages to show off new products, product lines, or catalogs of products. When a website is updated to display such products it may be a labor intensive and time consuming undertaking just to get the new Web pages designed and deployed. For example, the process for updating a website to display a new product line may involve a design process in which the visual content and experience is created (e.g., the look and feel of how an Internet user may see and experience the Web page(s) related to the new product release), a business logic design process (e.g., what metrics and information will be tracked on the Web page(s) related to the new product release), a graphic design process where the visual elements are created for the Web page(s), a Web development and quality testing phase where the Web page(s) are coded (e.g., in HTML, JavaScript, etc.) and tested, and then a development operations phase in which the Web page(s) are deployed to a web server. As can be appreciated from this exemplary workflow, rolling out a new Web page or pages can be a very time-consuming task. Further complications can arise if the deployed Web page design does not perform well and that may trigger a repeat of all or a portion of the above-described development workflow, which may result in any changes that are to be made occurring too late (e.g., due to the time-is-of-the-essence nature of product releases).

### SUMMARY

The present disclosure provides systems and methods for dynamically generating, managing, and optimizing interactive Web content. In particular, the disclosed systems and methods provide a generative artificial intelligence (AI) model configured to provide functionality that supports automated generation of Web page, including: (1) creation of the visual content for the Web page(s) (e.g., including both Web page design and visual elements); (2) creation of the Web page experience(s) (e.g., the types of interactions and engagements that will be presented/provided to an Internet user); and (3) creation of the business and coding logic (e.g., HTML coding, JavaScript, other programming logic, metrics and performance tracking logic, tagging, effects, and the like). Using the aforementioned functionalities, the generative AI model may be configured to receive a prompt as input and transform the prompt into a set of visual content elements, experience design elements, and business and coding logic that may be combined into one or more functional Web pages that may be deployed directly to a Web server where the Web page(s) may be accessed by Internet users.

In addition to automating generation of Web pages, the disclosed systems and methods provide functionality for managing Web pages created and deployed using the techniques described above. For example, the disclosed systems and methods may be configured to track metrics associated with the performance of deployed Web pages and to utilize the metrics to manage the deployed Web pages. The tracked metrics may include metrics to track interactions with interactive elements of the Web pages, such as an amount of time a mouse pointer is hovered over an element of a Web page, traffic, conversions, and the like. The tracked metrics may be provided as feedback that may be used by the disclosed systems and methods to evaluate performance of the Web pages deployed in accordance with the concepts described herein.

As a non-limiting example, the generative AI model described above may generate multiple different variants of a Web page and/or Web page experience in connection with an online campaign (e.g., a product launch, a collection release, etc.). As explained above, the different variants of the Web page and experience may each have visual elements (e.g., Web page design elements, such as carousels, images, branding information, text, buttons, etc.), an experience design (e.g., information defining how a user would interact with the Web page and any linked pages of the website, such as shopping cart and checkout pages), and business coding logic. The metrics may be obtained based on the business coding logic, which may be configured to track various interactions between Internet users and each of the variants of the Web page(s). Using the metrics provided as feedback, performance of each variant of the Web page(s) may be evaluated and determinations may be made regarding whether to retire a variant or keep the variant in publication.

For example, if a Web page is created with three different variants, each having at least different visual content, design elements, experience elements, or a combination thereof, and the first variant is performing poorly relative to the other two variants according the tracked metrics, the first variant may be removed from the Web server or simply deactivated (i.e., no longer shown to Internet users) while the better performing Web page variants may remain in circulation. In this manner, only those Web pages that perform well may be used and the impact of a poor design, experience, or other aspect of a Web page may be minimized (e.g., by the ability to quickly observe the poor performance and remove the variant from circulation). Furthermore, if all variants perform poorly, the generative AI model may be utilized to quickly generate additional variants that may be deployed, hopefully with at least one Web page that performs well. In an aspect, the generative AI model may also be retrained using the metrics obtained as feedback. For example, the metrics may be used to train the generative AI model on which variants of Web pages performed poorly, enabling the generative AI model to create better Web pages initially and reducing the likelihood that a variant of a Web page performs poorly once deployed.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed methods and apparatuses, reference should be made to the implementations illustrated in greater detail in the accompanying drawings, wherein:

FIG. 1 is a block diagram of an exemplary system for dynamically generating, managing, and optimizing interactive Web content according to aspects of the present disclosure;

FIG. 2 is a block diagram illustrating an exemplary Web page generated in accordance with the present disclosure;

FIG. 3 is a block diagram illustrating exemplary interactive content experience generated in accordance with aspects of the present disclosure;

FIG. 4 is a block diagram illustrating aspects of tracking performance of Web pages generated in accordance with aspects of the present disclosure; and

FIG. 5 is a flow diagram of an example method for generating, managing, and optimizing interactive Web content according to aspects of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

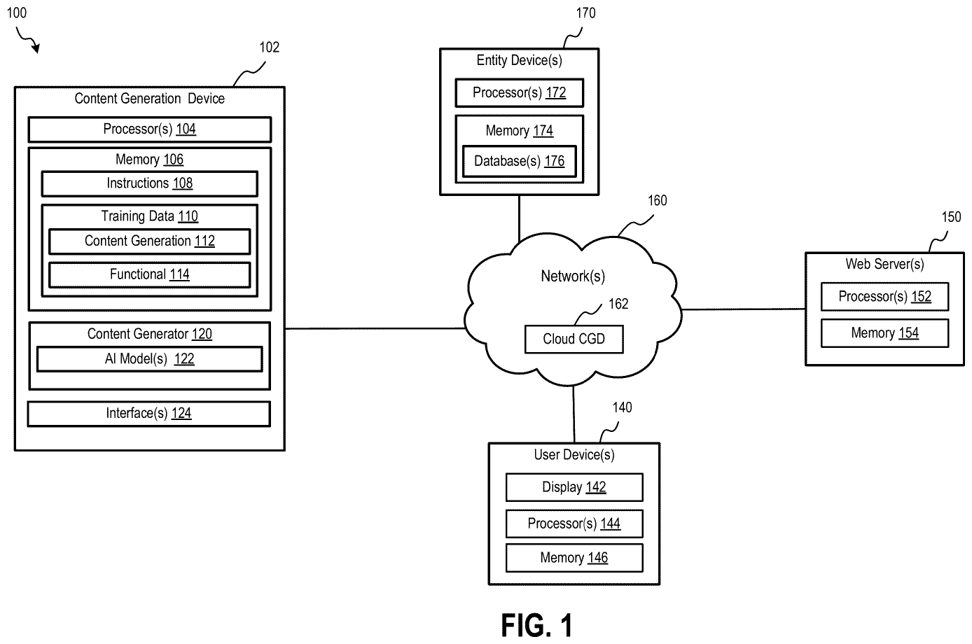

Referring to FIG. 1, a block diagram of an exemplary system for dynamically generating, managing, and optimizing interactive Web content according to aspects of the present disclosure is shown as a system 100. As shown, the system 100 includes a content generation device 102. The content generation device 102 may be communicatively coupled to one or more external devices or systems to facilitate generation and management of interactive Web content using the techniques described herein. For example, content generation device 102 may be communicatively coupled via the one or more networks 160 to an entity device 170, which may be a computing device associated with an for which the functionality of the content generation device 102 is applied to generate and manage interactive Web content. The entity device 170 may be a server, a data store, or other type of computing device having one or more processors 172 and a memory 174. The memory 174 may include one or more databases 176 storing images and other visual content that may be incorporated into Web content by the content generation device 102, as described in more detail below.

The content generation device 102 may also be communicatively coupled to one or more Web servers 150 via the one or more networks 160. The Web servers may include one or more processors 152 and a memory 154 and be configured to host Web pages. For example, the content generation device 102 may be used to generate Web pages that may be deployed to the Web server(s) 150. Once deployed, the Web pages may be accessed by one or more Internet users via one or more user devices 140. The user devices 140 may include a display device 142, one or more processors 144, and a memory 146. The user devices 140 may include smartphones, laptop computing devices, desktop computing devices, tablet computing devices, gaming consoles, or other types of electronic devices capable of accessing Web pages generated by the content generation device 102.

As shown in FIG. 1, the content generation device 102 includes one or more processors 104, a memory 106, and one or more interfaces 124. The one or more processors 104 may include one or more microcontrollers, application specific integrated circuits (ASICs), field programmable gate arrays (FPGAs), central processing units (CPUs) and/or graphics processing units (GPUs) having one or more processing cores, or other circuitry and logic configured to facilitate the operations of the content generation device 102 in accordance with aspects of the present disclosure. The memory 106 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. Software configured to facilitate operations and functionality of the content generation device 102 may be stored in the memory 106 as instructions 108 that, when executed by the one or more processors 104, cause the one or more processors 104 to perform the operations described herein with respect to the content generation device 102, as described in more detail below. Additionally, the memory 106 may be configured to store one or more databases, such as databases storing training data 110 that may be used to train one or more generative AI models. The training data 110 may include content generation training data 112 (e.g., training data that may be used to train the generative AI model to generate visual aspects and experiences of Web pages) and functional training data 114 (e.g., training data that may be used to generate code to support business logic and other functionality for managing Web pages).

The content generation device 102 includes a content generator 120 having one or more generative AI models 122. The content generator 120 may be configured to use the generative AI model(s) 122 to generate Web pages that may be deployed to the one or more Web servers 150. For example, the generative AI model(s) 122 provides functionality to support: (1) creation of the visual content for the Web page(s) (e.g., including both Web page design and visual elements); (2) creation of the Web page experience(s) (e.g., the types of interactions and engagements that will be presented/provided to an Internet user); and (3) creation of the business and coding logic (e.g., HTML coding, JavaScript, other programming logic, metrics and performance tracking logic, tagging, effects, and the like) to support backend functionality and/or interactivity functionality of the Web pages.

Using the aforementioned functionalities, the generative AI model 122 of the content generator 120 may be configured to receive a prompt as input and transform the prompt into a set of visual content elements, experience design elements, and business and coding logic that may be combined into one or more functional Web pages that may be deployed directly to a Web server where the Web page(s) may be accessed by Internet users. For example, suppose that a prompt is received that states “create an experience to show off the fall collection of watches for Company A”. The content generator 120 may analyze the prompt and retrieve information associated with the fall collection of watches (e.g., from the one or more databases 176 of the entity device corresponding to Company A) and pass the prompt and the retrieved information to the generative AI model 122. The generative AI model may generate one or more Web page experiences in response to the prompt and based on the retrieved data. As used herein, “Web page experiences” refer to not just the visual elements (e.g., images, icons, graphics, background colors, fonts, logos, and the like)—instead “experiences” may include Web page sequences (e.g., in Web page 1 element 1 links to Web page 2, element 2 animates element 3, and the like), thereby defining how the Web pages both look and are experienced by the Internet user. For example, in a Web page associated with a shopping experience, the “experience” may include the initial product page (e.g., a Web page displaying one or more products), a product detail page (or animation to display product detail information), one or more animations on the product page, a transition to a shopping cart display page, and a checkout page. It is noted that other Web pages may also be included in such an experience. The experience may also include different types of visual presentations of content on the Web page, such as carousels, display grids (e.g., displaying products in rows and/or columns), and the like, as well as functional visual elements (e.g., filter tools, sorting tools, compare buttons, and the like). It is noted that in some instances many different Web page variants may be generated, where each variant has some visual or experience differences with respect to the other variants. The different variants may each be deployed to the Web server 150 and metrics associated with each variant may be monitored and evaluated to determine whether to retire or keep any of the variants active (i.e., accessible to the Internet users via the computing devices 140).

In addition to generating the visual aspects of the Web pages and the experience, the generative AI model 122 may also be trained to generate functionality associated with the Web pages. For example, the generative AI model 122 may be configured to generate tags for the Web pages, code to support tracking of metrics of the Web page(s) (e.g., track time spent on each Web page of an experience, time spent hovering a mouse over one or more visual elements of the Web page(s), elements that are clicked or activated on a Web page(s), conversions, use of carousels or other interactive elements of the Web page(s), and the like) and animation controls, and to support optimization of the Web page(s), such as to optimize the loading time of the Web page(s), support multiple device types (e.g., mobile devices, laptop computing devices, desktop computing devices, etc.), search engine optimizations, and the like. The code generated by the AI model 122 may include HTML, JavaScript, or other types of code to facilitate the optimization of the Web pages and to provide functionality associated with the experience and tracking of performance.

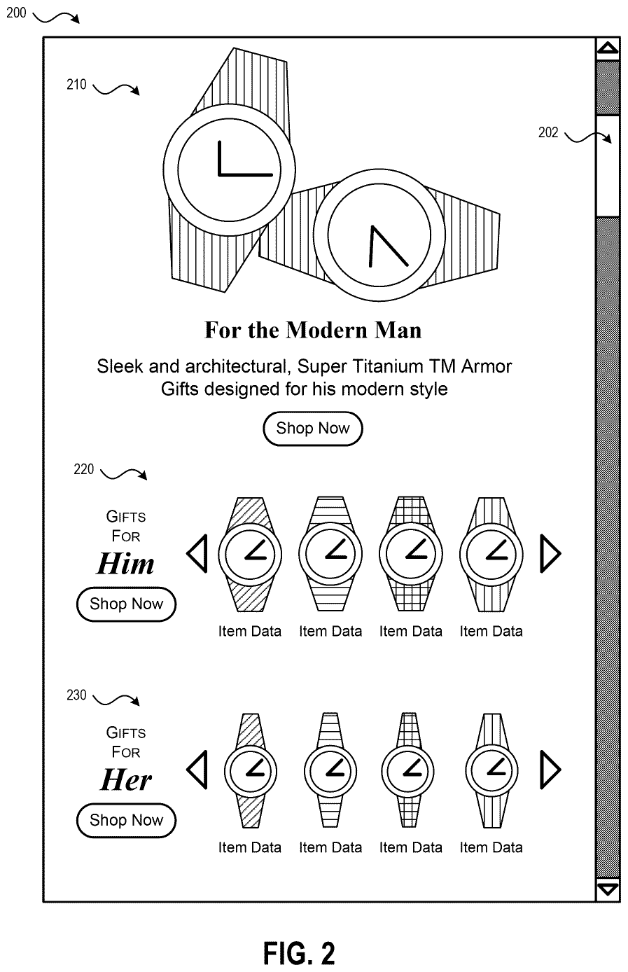

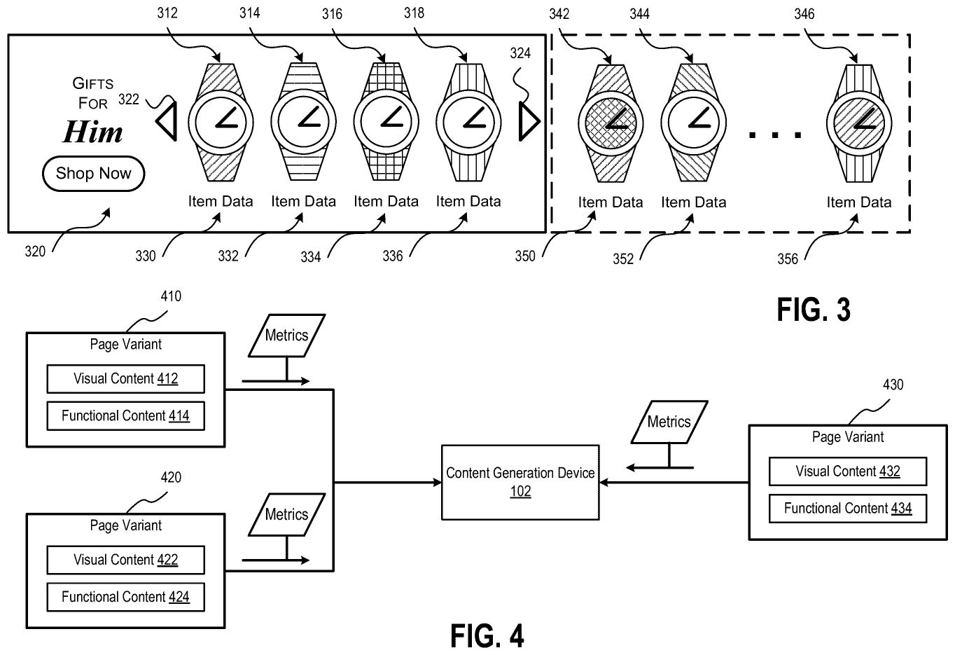

As a non-limiting example, and referring to FIG. 2, a block diagram illustrating an exemplary Web page generated in accordance with the present disclosure is shown as a Web page 200. The exemplary Web page 200 may be generated in response to a prompt, such as a prompt provided to the content generation device 102 of FIG. 1, as described above. As shown in FIG. 2, the Web page 200 includes display regions 210, 220, 230 and a slider bar 202. The display region 210 may show first visual content, depicted as a pair of watches and the display regions 220, 230 may be carousels showing additional visual content, shown as including additional images of watches. The first visual content may be rotated or changed, such as displaying a first watch image for a period of time or for a particular visit to the Web page 200 and visual content may be displayed during other periods of time or other visits to the Web page 200. The two carousel displays in the display regions 220, 230 may be interactive as described in more detail with reference to FIG. 3. As can be appreciated from the Web page 200 of FIG. 2, the content generation device 102 may generate interactive content for Web pages, which may include animations (e.g., via the carousels or other visual elements of the Web page), as well as business logic to enable performance monitoring and tracking. For example, the Web page 200 may include logic to track whether an Internet user hovers a mouse over any of the visual content on the Web page 200, clicks on any interactive elements (e.g., hyperlinked images, buttons, etc.), how long an Internet user spends viewing the Web page 200, whether the Internet user added any products displayed on the Web page 200 to a shopping cart, checked out or paid for those products, other pages visited by the Internet user, average order value (AOV) (e.g., basket size), conversion rates, or other metrics. The business logic associated with the code created by the generative AI model may also include logic to select which visual elements or content are displayed within the Web page. For example, in FIG. 2 the display regions 210, 220, 230 each includes various images of watches. The particular watches selected for presentation to an Internet user visiting a website that includes the Web page 200 may be determined based on the business logic, such that one Internet user may see a first set of watches (or other products and visual content) while another Internet user is shown a second set of watches (or other products and visual content). Thus, the business logic may also include logic that controls the visual content displayed within the generated Web page, which may include retrieving appropriate images and visual content from one or more remote datastores, such as the database 176 of FIG. 1. It is noted that the business logic may be generated to make use of extensive integrations into a technical ecosystem of a company (e.g., an entity associated with the entity device 170 of FIG. 1) coupled with knowledge of the subject matter and the business itself. For example, the business logic may be configured to cross-check available inventory or estimated ship/delivery dates before offering a product for upsell.

To further illustrate how the functionality of the generative AI model of the content generation device 102 generates interactive Web page experiences, and referring to FIG. 3, a block diagram illustrating exemplary interactive content experience is shown as a carousel 300, which may be the carousel shown in the display region 220 of FIG. 2. The exemplary carousel display shown in FIG. 3 includes visual elements 312, 314, 316, 318 depicting different styles of watches, graphics or icons 320 (e.g., a shop now button), 822 (e.g., a scroll left arrow), 824 (e.g., a scroll right arrow), and textual elements 830, 832, 334, 336, which are visible within the Web page 200 when initially displayed. Additional visual elements 342, 344, 346 may also be associated with the carousel and may become visible via activation of the icons 322, 324. For example, activation of the icon 324 may shifts the visual element 318 (and associated textual element 336) out of view to the right and brings the visual element 346 (and associated textual element 356) into view from the left (e.g., visual element 318 disappears, visual element 346 replaces visual element 312 as the leftmost visual element, and visual elements 314, 316 and associated textual elements shift right). Similar actions may occur in the reverse direction via activation of the icon 322. Successive activation of the graphics or icons 322, 324 may enable the Internet user to scroll through the images 312-318 and 342-346 while shifting the images left or right with each activation. As noted above, the particular visual elements displayed within the carousel shown in FIG. 3, as well as the order in which the visual elements are displayed, may be generated by the generative AI model, which may pull at least some of the visual elements (e.g., the images of watches or other products) from a data source, such as the one or more databases 176 of FIG. 1 (e.g., product catalog databases). Once the visual elements of the Web page 200 is designed, the generative AI model may also generate appropriate code (e.g., HTML, JavaScript, etc.) to facilitate animation of the carousel display during display of the experience corresponding to the Web page 200. Also, it is to be understood that the generative AI model may create multiple variants of the Web page 200, such as to include different carousels (e.g., carousels having different products, arrangements of the same products, etc.), more carousels or less carousels, other types of interactive Web page content, and the like.

Referring back to FIG. 1, in addition to generating the visual elements and design of the Web page(s), as well as the experience and associated functionality to support tracking of metrics, the content generation device 102 may also provide functionality to use the tracked metrics to monitor performance of the Web page(s), including different variants of a single Web page. As an example, suppose the generative AI model 122 created 5 variants of the Web page 200 of FIG. 2, each having differences with respect to visual elements, layout, experience, or other aspects of the Web page and/or experience. Each of the Web page variants may have metrics that may be tracked using the functionality created by the generative AI model 122 of FIG. 1. The tracked metrics may be used to evaluate the performance of each variant, such as to track time spent on the Web page for each variant, conversions, page loading metrics, search engine rankings or ratings, other types of Web page interactions or metrics, or a combination thereof. The tracked performance metrics may be used to determine whether any of the variants of the Web page perform poorly, and poor performing variants may be taken out of circulation (e.g., removed from the Web server 150 or otherwise marked or designated to not be shown to Internet users). In this manner, testing of different Web page variants may be performed quickly and poor performance may be identified quickly, which may improve the performance of the website associated with the Web page. Furthermore, variants optimized to different devices may be generated (e.g., elements of a generated Web page may be varied across the different variants to optimize Web page loading times for different types of devices, such as mobile and non-mobile devices.

As an illustrative example, and referring to FIG. 4, a block diagram illustrating aspects of tracking performance of Web pages generated in accordance with aspects of the present disclosure is shown. In particular, FIG. 4 shows 3 Web page variants 410, 420, 430, where each variant includes visual content 412, 422, 432 and functionality content 414, 424, 434, respectively. The functional content 414, 424, 434 may be used to track performance metrics that may be received by the content generation device 102 of FIG. 1. If the variant 420 is determined to perform poorly relative to the variants 410, 430, the content generation device 102 may eliminate the variant 420 from circulation, leaving only variants 410, 430 in circulation. By removing poorly performing variants the overall performance of the website may be improved, such as to improve page loading performance, interaction with elements of the website, search engine rankings, and the like. Additionally, it is noted that where the performance of all or a threshold number of variants perform poorly based on evaluation of the tracked metrics, new variants may be automatically generated to replace the poorly performing variants. For example, if variants 410, 420 (and possible variant 430) were determined to not satisfy a threshold performance level with respect to the tracked metrics, the generative AI model 122 of the content generation device 102 may be utilized to generate new variants that may be deployed to the Web server(s) 150 of FIG. 1. Because original or replacement variants may be generated automatically by the generative AI model 122, many of the delays related to existing manual processes may be eliminated. Furthermore, due to the ability to incorporate automatic generation of functionality that supports tracking of performance metrics, testing and evaluation of the performance of the Web pages may enable poor performing Web pages to be identified quickly, which enables new Web pages or variants to be generated in a time frame that is still relevant (e.g., while a product launch is still fresh and of interest to Internet users).

To further illustrate the concepts described above, the content generation device 102 of FIG. 1 may generate variants that impact the look and feel of the content (e.g., the visual elements, layout, arrangements, color schemes, text, fonts, etc.) as well as the very nature of each variant (e.g., the experience, goals, and the like). To illustrate, suppose the content generation device 102 generates 3 different Web page experience variants. Each variant may have a different look and feel of the content. For example, the first variant may include a grid of products, the second variant may include a main product display area (e.g., the display area 210 of FIG. 2) and a single carousel (e.g., one of the carousels shown in the display areas 220, 230 of FIG. 2), and the third variant may include a main product display area and two carousels. In addition to including different arrangements of interactive elements and other visual content of the Web page(s) associated with each variant, the content generation device 102 may also be configured vary the specific product(s) displayed, types of products displayed (e.g., multiple products in the same product type, such as watches, or different products, such as accessories for a featured product). Additionally, some variants may be generated with the same visual arrangement or display areas, but be configured to display different sets of products. For example, if variants are generated with a goal of increasing AOV, one variant may be configured to display all products in a particular category while another variant may be configured to display a subset of the products in connection with accessories to the featured subset of products. Feedback may be received in connection with these different variants which may indicate that one variant has a higher AOV than the other variant(s). Since the goal of the different variants was to improve AOV, the variant(s) associated with higher AOVs may be maintained in circulation while the other variants may be removed from circulation.

Additionally, the content generation device 102 may generate variants that may be the same or different in terms of visual content, but may have different experiences. For example, a first variant may have a first sequence of Web pages and interactions and a second variant may have a second sequence of Web pages and interactions that are at least partially different from the first variant. As a non-limiting example, suppose the first and second variants were similar to the Web page shown in FIG. 2. For the first variant, clicking on or hovering a mouse over the display area 210 may cause product details to be displayed in the display area 210, while in the second variant clicking on the display area 210 may cause a pop-up window to be presented that includes the product details or may cause a product detail Web page to be presented in the same browser window. As another example, the first variant and the second variant may be similar to that shown in FIG. 2, but the carousels of the first variant may include accessories to the product displayed in the display region 210 and the second variant may present an accessories Web page in response to adding a product shown in the second variant to a shopping cart. Other differences in the experience of the Internet user may be utilized to created different variants. The particular product(s) displayed in a variant may also vary based on a variety of factors. For example, an experience associated with a first variant may be configured to display a set of site-wide best-seller products and a second variant may be configured to display regional best-seller products. A third variant could be generated to display adjacent product category best-sellers.

In an aspect, the particular variant presented to a user (e.g., by the Web server 150 of FIG. 1) may be determined based on information associated with the Internet user. For example, if the Internet user is a known user (e.g., has an account with an entity corresponding to the Web page or website), account preferences of the Internet user may be used to serve the Internet user a particular variant. In an aspect, variants may also be generated based on feedback from prior Web pages and experiences generated by the content generation device 102 and configured for presentation to particular types of users. For example, one or more variants may be generated for new or first time users while other variants may be generated for existing users, which may include different variants for different types of existing users.

As briefly illustrated above, the content generation device 102 generates variants that may include many different combinations of visual elements, experiences, and targets performance metrics (e.g., increase AOV, load times, and other business and performance metrics). The content generation device 102 is also configured to track and monitor the performance metrics to see which variants result in the desired performance targets. The feedback provided via the monitored performance metrics may be used to determine whether to retire or maintain circulation of one or more variants. It is noted that the determination to retire or maintain circulation of variants in various ways, such as to retire a particular variant for one type of Internet user but maintain the variant in circulation for another type of user. In addition to retiring or maintaining variants in circulation based on types of users (e.g., luxury buyer, new Internet customer, existing customer, repeat website visitor, and the like), other metrics and factors (e.g., geographic locations of Internet users, demographics of Internet users, browsing history, and the like) may also be tracked and/or observed from the feedback and utilized to determine whether to retire or maintain variants in circulation. For example, variants may be retired or maintained in circulation based on observed performance across metrics such as AOV, Web page loading times, or other performance metrics tracked by the content generation device 102. Furthermore, variants may be retired and/or maintained in circulation based on combinations of different performance metrics, thereby enabling more complex performance targets to be designed and utilized to improve the overall performance of one or more Web pages, an entire website (e.g., a website including the one or more Web pages generated in accordance with the concepts described herein), and/or the experiences associated with each of the one or more Web pages or the website as a whole.

Additionally, it is noted that the feedback may also be used to train the generative AI model to design and create better Web pages (e.g., Web pages and/or Web page experiences that optimize one or more performance targets), which may be based on one or more performance targets specified in the prompt presented to the generative AI model. For example, the prompt used to generate a Web page may specify one or more performance target goals and the generative AI model may design different variants based on insights learned for the specified performance target goals (e.g., a first set of variants may be generated to optimize for a first performance target or set of targets, but a second set of variants may have be generated if the performance target goals were different). Furthermore, as explained above, the feedback and insights learned from the monitored performance metrics may also result in generation of additional variants that may be placed in circulation (e.g., deployed to the Web server 150) either to replace previously generated variants or to further experiment with identifying variants providing a target level of performance, or other factors. The generation of new variants may also account for knowledge of the business logic of deployed variants and how that business logic may have impacted performance, which may result in new variants having at least partially different business logic in an effort to optimize the new variant across target performance metric goals. In view of the foregoing it should be understood that the concepts disclosed herein may be utilized to generate Web pages and associated experiences that may be tracked across a variety of performance metrics, where the tracked performance metrics may be used to retire and/or maintain each variant in circulation, and that whether performance metrics indicate a variant should be retired or maintained in circulation may further account for other factors (e.g., target populations of Internet users/website visitors, geographic regions, demographics, and the like) such that a variant may be determined to perform well for some circumstances and be maintained in circulation (e.g., a variant may be maintained in circulation for a specific type of group of Internet users, such as repeat customers) but retired from circulation in other circumstances.

Using the concepts described herein, entities may be enabled to design, create, and deploy websites offering Web pages having unique and engaging experiences (e.g., everything from a website home page to product display page to checkout and everything in between) at scale in a rapid amount of time. The disclosed invention reduces the time to deployment from weeks or months to a matter of minutes or hours, thereby enabling rapid testing of the performance of Web page and experiences and also enabling new Web pages and experiences to be created in response to tracked performance metrics. Furthermore, the invention may enable entities to optimize performance of their websites across a variety of trackable performance metrics with reduced costs (e.g., computational costs, time costs, manpower costs, etc.) while offering the flexibility to tailor experiences and business logic across an entities entire business ecosystem.

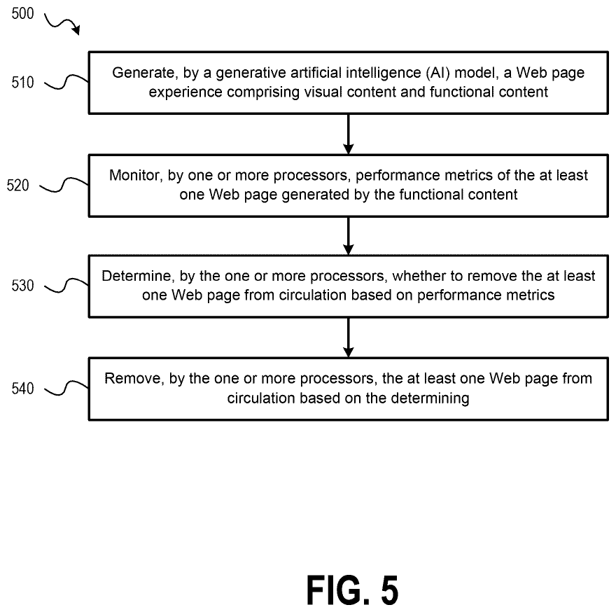

Referring to FIG. 5, a flow diagram of an example method for dynamically generating, managing, and optimizing interactive Web content according to aspects of the present disclosure is shown as a method 500. In an aspect, the method 500 may be stored as instructions (e.g., the instructions 108 of FIG. 1) that, when executed by one or more processors (e.g., the one or more processors 104 of FIG. 1), cause the one or more processors to perform operations according to the steps of the method 500. In an aspect, the method 500 may be performed by a system, such as the system 100 of FIG. 1.

At step 510, the method 500 includes generating, by a generative artificial intelligence (AI) model, a Web page experience comprising visual content and functional content. In an aspect, the Web page experience may include at least one Web page. In some implementations the Web page experiences may include a plurality of Web pages. At step 520, the method 500 includes monitoring, by one or more processors, performance metrics of the at least one Web page generated by the functional content. In an aspect, the monitoring may be performed as described above with reference to FIGS. 1-4. At step 540, the method 500 includes determining, by the one or more processors, whether to remove the at least one Web page from circulation based on performance metrics. In an aspect, the method 500 may include, at 540, removing the at least one Web page from circulation based on the determining (e.g., at step 530).

In an aspect, the method 500 may include additional operations described above with reference to FIGS. 1-4. For example, the method 500 may include generating a plurality of variants of the Web page experience, where at least one variant of the Web page experience remains in circulation after the removing. In an aspect, the method 500 may include generating a plurality of variants of the Web page experience, where the at least one Web page corresponds to a first variant of the plurality of variants. In an aspect, the Web page experience is generated by the generative artificial intelligence model in response to a prompt. In an aspect, the generative AI model is configured to incorporate visual content into the Web page experience based on information obtained from a data source. In an aspect, the visual content is determined based on business logic generated by the AI model. In an aspect, the method 500 may include training the generative AI model based on the monitored performance metrics. As explained above, the training may be configured to modify an experience corresponding to the at least one Web page based on the performance metrics, modify business logic of the at least one Web page, modify the visual content of the at least one Web page, or a combination thereof. In an aspect, the at least one Web page removed from circulation based on performance metrics is removed for a first population of Web page visitors and maintained in circulation for a second population of Web page visitors.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-4 include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules, and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may also be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

1. A method for dynamically generating, managing, and optimizing interactive Web content, the method comprising:
generating, by a generative artificial intelligence (AI) model, a Web page experience comprising visual content and functional content, wherein the Web page experience comprises at least one Web page;
monitoring, by one or more processors, performance metrics of the at least one Web page generated by the functional content; and
determining, by the one or more processors, whether to remove the at least one Web page from circulation based on performance metrics.

2. The method of claim 1, further comprising removing the at least one Web page from circulation based on the determining.

3. The method of claim 2, further comprising generating a plurality of variants of the Web page experience, wherein at least one variant of the Web page experience remains in circulation after the removing.

4. The method of claim 1, further comprising generating a plurality of variants of the Web page experience, wherein the at least one Web page corresponds to a first variant of the plurality of variants.

5. The method of any of claim 1, wherein the Web page experience is generated by the generative artificial intelligence model in response to a prompt.

6. The method of claim 1, wherein the generative AI model is configured to incorporate visual content into the Web page experience based on information obtained from a data source.

7. The method of claim 6, wherein the visual content is determined based on business logic generated by the AI model.

8. The method of claim 1, further comprising training the generative AI model based on the monitored performance metrics, wherein the training is configured to modify an experience corresponding to the at least one Web page based on the performance metrics, modify business logic of the at least one Web page, modify the visual content of the at least one Web page or a combination thereof.

9. The method of claim 1, wherein the at least one Web page removed from circulation based on performance metrics is removed for a first population of Web page visitors and maintained in circulation for a second population of Web page visitors.
